(19) United States
(12) Patent Application Publication
(10) Pub. No.: US 2009/0227437 A1
(43) Pub. Date: Sep. 10, 2009

(54) APPARATUS FOR RECEIVING GUIDE ELEMENTS AND TOOLS OF A FOLDING BOX GLUING MACHINE

(75) Inventors: Wolfgang Diehr, Grevenbroich (DE); Maik Stumberger, Hilden (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AKTIENGESELLSCHAFT, Heidelberg (DE)

(21) Appl. No.: 12/398,495

(22) Filed: Mar. 5, 2009

(30) Foreign Application Priority Data
Mar. 5, 2008 (DE) 10 2008 012 776.0

(51) Int. Cl. B31B 49/00; B65H 1/16

(52) U.S. Cl. 493/468; 493/478; 414/806

(57) ABSTRACT

A receiving apparatus of a folding box gluing machine for receiving guide elements, in particular a roller rail, and/or tools, such as folding devices. The guide elements and/or tools can be moved from an active position above the folding box transport plane into a parked position. The receiving apparatus has a frame, to which the guide elements and/or tools are fastened, and this frame can be pivoted about a pivot axis, the pivot axis being oriented parallel to the folding box transport direction. The receiving apparatus has a stop device which fixes the position of the frame in its parked position, with the result that said frame can be reached ergonomically by the machine operator. The frame can be moved from a horizontal position, in which the guide elements and/or tools are situated in their active position, by a pivoting movement about the pivot axis by less than 90° into an oblique position, in which the guide elements and/or the tools are situated in their parked position.

### CROSS-REFERENCE TO RELATED APPLICATION

This application claims the priority, under 35 U.S.C. §119, of German patent application DE 10 2008 012 776.0, filed Mar. 5, 2008; the prior application is herewith incorporated by reference in its entirety.

### BACKGROUND OF THE INVENTION

1. Field of the Invention

The invention relates to an apparatus for receiving guide elements and/or tools of a folding box gluing machine. The machine receives guide elements, in particular a roller rail, and/or tools, such as folding devices. It is possible for the guide elements and/or tools to be moved from an active position above the folding box transport plane into a parked position. The receiving apparatus has a frame, to which the guide elements and/or tools are fastened. It is possible for the frame to be pivoted about a pivot axis, the pivot axis is oriented parallel to the folding box transport direction.

In a known way, folding box gluing machines for producing folding boxes from blanks have at least the following processing stations:
a feeder which pulls off at high speed the blanks to be processed from a stack one after another and feeds them individually to the following processing station;
a folding station, in which the blank parts which are provided with an adhesive stripe are doubled over by 180°, that is to say are folded, in order to produce an adhesively bonded join;
a transfer station which feeds the folded blanks, which are provided with adhesive seams which have not yet set, to the following gathering and pressing device such that they are aligned exactly in all parts; and
a gathering and pressing device, in which first of all an imbricated stream is formed from folded blanks, which imbricated stream is subsequently held for some time under pressure between press belts, in order that the adhesive seams set.

Depending on the type of box to be produced, the machine can contain further processing stations; for example, one or more pre-breakers, in which folding tabs are folded forward and back, in order that the corresponding longitudinal groove lines are made soft and flexible by being bent by 180°, and further folding stations, in order to carry out additional folds. An application unit for adhesive which applies an adhesive stripe to the folding tabs to be adhesively bonded is usually arranged at the beginning of a folding station.

The blanks are conveyed through the individual stations by driven conveying means. Two or more conveyor belt pairs are used as driven conveying means, which are arranged at a transverse spacing in such a way that they guide the blanks while being held from the top and from the bottom.

Depending on the width of a folding box blank which is transported through the folding box gluing machine, it can be necessary that the blank is also transported in the center. In this case, it is possible to insert a center transport into the folding station or to feed it into the transport plane of the folding box blanks. According to the prior art, this takes place by virtue of the fact that the upper transport belt which is guided in what is known as a roller rail is fed into the transport plane from above via guides. The lower central transport belt which is guided in what is known as a roller cheek has to be installed separately into the folding box gluing machine or can also be placed into the transport plane by being folded upward. In the case, in which the blanks to be folded are very narrow and the two outer transport belts of the folding box gluing machine are guided together very narrowly, the lower central transport belt and the upper central transport belt have to be removed from the machine again.

In order to introduce and remove guide elements and/or tools, it is known to fasten the guide elements and/or tools to a frame. The frame can then either be displaced by motor along a vertical axis into a higher position or can be moved from its vertical active position into a horizontal parked position by being pivoted by 90°. The disadvantages of these prior art solutions are the complicated construction in the first case and the low ergonomic level and existing risks during the operation of the frame in the second case.

### SUMMARY OF THE INVENTION

It is accordingly an object of the invention to provide a receiving apparatus of a folding box gluing machine for receiving guide elements and/or tools which overcomes the above-mentioned disadvantages of the heretofore-known devices and methods of this general type and which receiving apparatus is distinguished by a simple construction and a high degree of ergonomics and operating safety.

With the foregoing and other objects in view there is provided, in accordance with the invention, a receiving apparatus of a folding box gluing machine wherein folding box blanks are conveyed along a given transport direction in a folding box transport plane, and wherein guide elements and/or tools are movably disposed between an active position thereof above the folding box transport plane and a parked position. The receiving apparatus comprises:

a frame for fastening thereon the guide elements and/or tools, said frame being pivotally mounted about a pivot axis extending parallel to the folding box transport direction; and

a stop device configured to define a parked position of said frame, wherein said frame is pivotable from a horizontal position, in which the guide elements and/or tools are situated in the active position above the folding box transport plane, by a pivoting movement about said pivot axis of less than 90° into an oblique position, in which the guide elements and/or tools are situated in the parked position.

The receiving apparatus serves to receive guide elements, such as, in particular, roller rails and/or tools, such as folding devices or other additional devices. The receiving apparatus can be used at different positions within the folding box gluing machine and the receiving apparatus is fitted with guide elements and/or tools according to the requirements which are present there. The guide elements and/or tools are fastened to a frame which is part of the receiving apparatus. If the frame is situated in its horizontal position, what is known as the active position, the guide elements and/or tools which are attached to the frame are then situated in their active position in or directly above the folding box transport plane. The frame can be moved from its horizontal position into an oblique position about a pivot axis which is oriented parallel to the folding box transport direction. In the oblique position, the guide elements and/or tools are out of engagement in what is known as their parked position. Here, the position of the frame in its parked position is fixed by a stop device in such a way that the frame passes through an angle of less than 90° during the pivoting movement from its active position into its parked position.

The stop device advantageously has an adjustable stop element, such as a setting screw. The height of the frame in its parked position can be fixed by the adjustability of the stop element and the machine operator can set it in such a way that he can grip the frame of the receiving apparatus without problems and ergonomically with a hand.

In one advantageous development of the invention, the guide elements and/or tools are fastened displaceably to the frame.

In one particularly advantageous embodiment of the receiving apparatus, it has at least one gas pressure spring which moves the frame from its horizontal position into its oblique position and holds the frame in its oblique position. The use of two gas pressure springs is particularly advantageous, which gas pressure springs are fastened to the frame in such a way that the latter does not experience a rotation during the pivoting movement.

In one particularly advantageous development of the receiving apparatus, a locking device for temporarily fastening the frame to the machine frame of the folding box gluing machine is attached on that side of the frame which lies opposite the pivot axis. In one advantageous embodiment, the locking device comprises at least one guide element and at least one latching and centering element. In addition, the locking device can further comprise a locking element or a plurality of locking elements. In one advantageous refinement, the guide element is a recess or groove which engages into a corresponding element which is attached to the machine frame. The latching and centering element is a hole which receives the head of a screw which is attached to the machine frame or a pin which is connected to the machine frame. The locking element can be a securing screw, a star handle, a cruciform handle and/or a clamping lever. Similar guide elements, latching and centering elements and locking elements with the same action which are not mentioned here can likewise be used.

In one advantageous development of the receiving apparatus, the latter has a braking device which brakes the pivoting movement which is caused by the at least one gas pressure spring. Here, the braking device can advantageously be attached between the frame and the machine frame of the folding box gluing machine. The braking device can be, for example, a hydraulic cushioning cylinder or a controllable pneumatic cylinder. The use of a controllable pneumatic cylinder is particularly advantageous, since it not only brakes the pivoting movement which is caused by the gas pressure springs, but can also assist the pivoting down of the frame from its parked position into its active position.

With the above and other objects in view there is also provided, in accordance with the invention, a method of moving a frame of a receiving apparatus from an active position into a parked position and vice versa. The method is performed with an apparatus as outlined above that is provided with a locking device for temporarily fastening the frame to a machine frame of the folding box gluing machine, the locking device being disposed on a side of the frame opposite the pivot axis and including at least one latching and centering element. The steps for moving the frame from the active position into the parked position include:
a) canceling an action of the latching and centering element of the locking device;
b) pivoting the frame with a gas pressure spring that is provided for pivoting the frame;
c) terminating the pivoting movement with a stop device; and
d) holding the frame in its obliquely pivoted position with the at least one gas pressure spring.
   The steps for moving the frame from the parked position into the active position include:
e) pivoting the frame from the oblique position as far as just before the horizontal position; and
f) further pivoting the frame assisted by the at least one guide element until the latching and centering element fixes the frame in the horizontal position.

In other words, in order to move the frame of a receiving apparatus from its active position into its parked position, the following steps are carried out: in a first step, the action of the latching and centering element is canceled. In a second step, the frame is pivoted upward, this pivoting movement being caused by the at least one gas pressure spring. In a third step, the pivoting movement is ended by the stop device. In a final step, the frame is held in its oblique position by the at least one gas pressure spring.

In order to move the frame of a receiving apparatus from its parked position into its active position, the following steps are carried out: in a first step, the frame is pivoted from its oblique position as far as just before its horizontal position. In a second step, the frame is pivoted further, this movement being assisted by the at least one guide element, until the latching and centering element fixes the frame in its horizontal position.

Other features which are considered as characteristic for the invention are set forth in the appended claims.

Although the invention is illustrated and described herein as embodied in an apparatus for receiving guide elements and tools of a folding box gluing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A shows an exemplary embodiment of a receiving apparatus according to the invention in its parked position and an indicated receiving apparatus in its active position;

FIG. 1B shows the receiving apparatus within an indicated folding box gluing machine in its active position;

FIG. 2A shows the receiving apparatus without adjoining elements; and

FIG. 2B shows a view of the receiving apparatus in order to illustrate the pivoting movement.

### DETAILED DESCRIPTION OF THE INVENTION

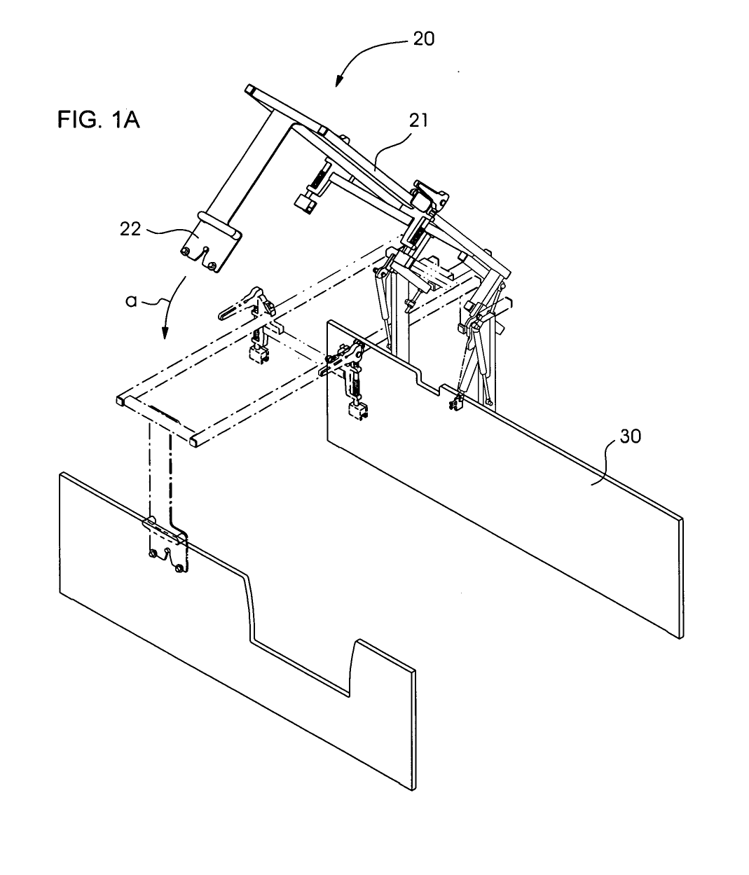

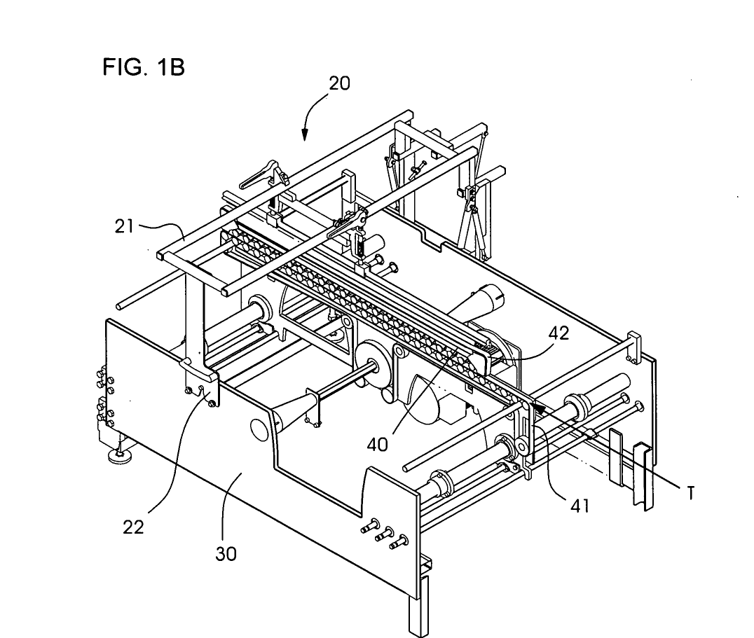

Referring now to the figures of the drawing in detail and first, particularly, to FIG. 1A thereof, there is shown a receiving apparatus 20 according to the invention of a folding box gluing machine, for receiving guide elements and/or tools. The frame 21 of the receiving apparatus 20 is situated in its parked position, in an oblique position which is pivoted out of the horizontal. From this oblique position, the frame 21 can be pivoted downward in the pivoting direction a and can be moved into its horizontal active position. The active position of the frame 21 is indicated in FIG. 1a. Here, the locking device 22 which is fastened to one end of the frame 21 comes into engagement with corresponding elements which are fastened to the machine frame 30 of the folding box gluing machine.

FIG. 1B shows an illustration of the frame 21 in its active position. Here, the adjoining elements of the folding box gluing machine and also the machine frame 30 of the folding box gluing machine are illustrated. A non-illustrated folding box blank is transported through the folding box gluing machine in a folding box transport direction T. In order to assist the transport of the folding box blank, the module (shown in FIG. 1B) of the folding box gluing machine has a central transport means. The latter is formed by a lower transport belt 41 and an upper transport belt 42. The lower transport belt 41 is part of an apparatus which can be secured in the module of the folding box gluing machine. The upper transport belt 42 is part of a guide element 40, of what is known as a roller rail. Said roller rail 40 is fastened to the frame 21 of the receiving apparatus 20 and can be moved from its shown active position into a parked position by the pivoting movement of the frame 21.

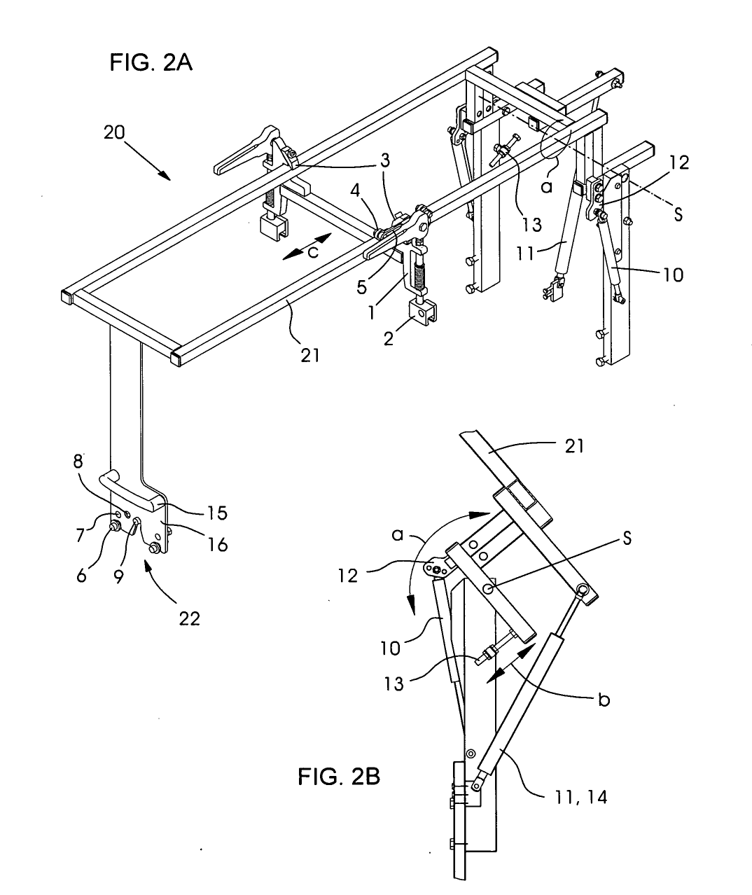

The fastening of the roller rail 40 to the frame 21 is shown in detail in FIG. 2A. Tools, such as folding devices or other additional devices, can also be attached instead of the roller rail 40. If they are not required, they can be pivoted out of the machine module into a parked position by a pivoting movement a of the frame 21. A roller rail 40 or a tool is clamped by the receptacles 2 of the lifting apparatus 1. In order to displace the roller rail 40 or a tool transversely with respect to the sheet transport direction T in the direction C along the frame 21 and to correctly position the roller rail 40 or the tool, the claws 3 are released. Here, the ball bearings 4 are deposited onto the square rods of the pivoting frame 21 and ensure an easy displaceability. Bent pieces of sheet metal 5 ensure that, during the transverse adjustment c of the roller rail 40 or the tool, the roller rail 40 or the tool remains oriented parallel to the transport direction T and therefore parallel to the lower transport belt 41 (not shown).

In order to pivot the frame 21 together with the guide element or tool out of the module of the folding box gluing machine, first of all the two securing screws 6 which are screwed into the machine frame 30 of the folding box gluing machine (not shown) are released. Subsequently, by pulling on the handle 15, the front plate 16 is guided over the centering screw 7 and the locking device 22 is therefore rendered inoperable. The pivoting movement a is assisted by the two gas pressure springs 10. A centrally installed hydraulic cushioning cylinder 11 which as an alternative can be replaced by a controllable pneumatic cylinder 14 operates counter to the force of the gas pressure springs 10, in order thus to avoid the pivoting frame 21 bouncing upward. The gas pressure springs 10 are connected at their one end to a plate 12 which is connected to the frame 21 and at their other end to the machine frame 30. In order to adapt the active force of the gas pressure springs 10 to the requirements which are dependent on the location of use of the receiving apparatus 20 and the tools or guide elements 40 which are fastened to the frame 21, the plate 12 is provided with various holes, via which the gas pressure spring 10 can be connected to the plate 12. Here, the gas pressure springs 10 are to be set in such a way that they bring about the pivoting movement a of the frame 21 about the pivot axis S and to hold the pivoting frame 21 in its pivoted out oblique position, its parked position. If the frame 21 is situated in its parked position, the frame 21 bears against the head of the setting screw 13 of the stop device. By rotation of the setting screw 13, the machine operator can vary the angle of the parked position and therefore fix the height of the handle 15, with the result that said handle 15 can also be reached in the parked position by the machine operator without problems and ergonomically.

In order to move the pivoting frame 21 into its active position, the machine operator can pull the pivoting frame 21 downward on the handle 15. Here, the locking of the frame 21 is ensured by the locking device 22. The screw 9 which is fastened to the machine frame 30 serves to center the front plate 16, the oval head screw 8 deflects the front plate 16 and keeps it at a spacing until the two centering screws 7 latch with the oval head screw 8 at the same time. The frame 21 is therefore fixed in its active position via the locking device 22. In addition, the securing screws 6 are tightened. Clamping levers, star handles or cruciform handles can also be situated there instead of the securing screws 6.

FIG. 2B shows a detail of a view of the receiving apparatus 20 to illustrate the active elements of the pivoting movement a. As an alternative, the hydraulic cushioning cylinder 11 can also be configured as a controllable pneumatic cylinder 14. This has the advantage that it can additionally assist the lowering of the pivoting frame 21. A pneumatic button can thus be attached to the operator-side wall of the machine frame 30, by which pneumatic button the lowering of the pivoting frame 21 which is assisted by the controllable pneumatic cylinder 14 can be triggered.

1. A receiving apparatus of a folding box gluing machine wherein folding box blanks are conveyed along a given transport direction in a folding box transport plane, and wherein guide elements and/or tools are movably disposed between an active position thereof above the folding box transport plane and a parked position, the receiving apparatus comprising:
a frame for fastening thereon the guide elements and/or tools, said frame being pivotally mounted about a pivot axis extending parallel to the folding box transport direction; and
a stop device configured to define a parked position of said frame, wherein said frame is pivotable from a horizontal position, in which the guide elements and/or tools are situated in the active position above the folding box transport plane, by a pivoting movement about said pivot axis of less than 90° into an oblique position, in which the guide elements and/or tools are situated in the parked position.

2. The receiving apparatus according to claim 1, wherein the guide elements include a roller rail and the tools include folding devices.

3. The receiving apparatus according to claim 1, wherein the guide elements and/or tools are displaceably fastened to said frame.

4. The receiving apparatus according to claim 1, wherein said stop device includes an adjustable stop element.

5. The receiving apparatus according to claim 1, which further comprises at least one gas pressure spring configured to move said frame from the horizontal position into the oblique position and to hold said frame in the oblique position.

6. The receiving apparatus according to claim 1, which further comprises a locking device for temporarily fastening said frame to a machine frame of the folding box gluing machine, said locking device being disposed on a side of said frame opposite said pivot axis.

7. The receiving apparatus according to claim 6, wherein said locking device comprises at least one guide element, at least one latching and centering element, and at least one locking element.

8. The receiving apparatus according to claim 7, wherein said guide element is a recess or groove engaging into a corresponding element that is attached to the machine frame, said latching and centering element is a hole that receives a head of a screw attached to the machine frame, and said locking element is a device selected from the group consisting of a securing screw, a star handle, a cruciform handle, and/or a clamping lever.

9. The receiving apparatus according to claim 5, which further comprises a braking device configured to brake the pivoting movement caused by said at least one gas pressure spring.

10. The receiving apparatus according to claim 9, wherein said braking device is a hydraulic cushioning cylinder.

11. The receiving apparatus according to claim 9, wherein said braking device is a controllable pneumatic cylinder.

12. A folding box gluing machine, comprising a receiving apparatus according to claim 1.

13. A method of moving a frame of a receiving apparatus from an active position into a parked position and vice versa, which comprises:
providing the apparatus according to claim 1 with a locking device for temporarily fastening the frame to a machine frame of the folding box gluing machine, the locking device being disposed on a side of the frame opposite the pivot axis and including at least one latching and centering element;
for moving the frame from the active position into the parked position:
a) canceling an action of the latching and centering element of the locking device
b) pivoting the frame with at least one gas pressure spring;
c) terminating the pivoting movement with a stop device;
d) holding the frame in an obliquely pivoted position with the at least one gas pressure spring;
for moving the frame from the parked position into the active position:
e) pivoting the frame from the oblique position as far as just before the horizontal position;
f) further pivoting the frame assisted by the at least one guide element until the latching and centering element fixes the frame in the horizontal position.

14. A method of moving a frame of a receiving apparatus from an active position into a parked position, which comprises:
providing the apparatus according to claim 1 with at least one gas pressure spring for pivoting the frame, with a braking device for braking the pivoting movement caused by the gas pressure spring, and with a locking device for temporarily fastening the frame to a machine frame of the folding box gluing machine, the locking device including at least one guide element, at least one latching and centering element, and at least one locking element;
a) releasing the at least one locking element of the locking device;
b) unlatching the latching and centering element;
c) pivoting the frame with the at least one gas pressure spring;
d) limiting a pivoting speed with the braking device;
e) terminating the pivoting movement with the stop device; and
f) holding the frame in an obliquely pivoted position with the at least one gas pressure spring.

15. A method of moving a frame of a receiving apparatus from a parked position into an active position, which comprises:
providing the apparatus according to claim 1 with at least one gas pressure spring for pivoting the frame, with a braking device in the form of a controllable pneumatic cylinder for braking the pivoting movement caused by the gas pressure spring, and with a locking device for temporarily fastening the frame to a machine frame of the folding box gluing machine, the locking device including at least one guide element, at least one latching and centering element, and at least one locking element;
a) pivoting of the frame from an obliquely pivoted position as far as just before a horizontal position assisted by the controllable pneumatic cylinder;
b) further pivoting the frame assisted by the at least one guide element until the latching and centering element fixes the frame in the horizontal position; and
c) fastening the frame to the machine frame of the folding box gluing machine with the at least one locking element.
